(19) United States
(12) Patent Application Publication
(10) Pub. No.: US 2024/0211273 A1
(43) Pub. Date: Jun. 27, 2024

(54) MICROCONTROLLER THAT MAINTAINS CONTROL FUNCTION EVEN AFTER SOFT-RESET AND A CONTROLLING METHOD THEREOF

(71) Applicant: HYUNDAI AUTOEVER CORP., Seoul (KR)

(72) Inventor: Kyo Min Kim, Seoul (KR)

(73) Assignee: HYUNDAI AUTOEVER CORP., Seoul (KR)

(21) Appl. No.: 18/545,375

(22) Filed: Dec. 19, 2023

(30) Foreign Application Priority Data
Dec. 27, 2022 (KR) 10-2022-0185363

(51) Int. Cl. G06F 9/4401

(52) U.S. Cl. CPC G06F 9/4403

(57) ABSTRACT

A microcontroller performs a control function. The microcontroller comprises: a memory management unit (MMU) performing a soft reset process by initializing remaining areas excluding a working page area of a memory managed by the memory management unit of the microcontroller; a communication module maintaining a communication connection prior to the soft reset process as it is even after the soft reset process; and a microprocessor initialized according to the soft reset process.

### CROSS-REFERENCE TO RELATED APPLICATION

This application claims the benefit of and priority to Korean Patent Application No. 10-2022-0185363, filed on Dec. 27, 2022, the entire contents of which are incorporated herein by reference.

### BACKGROUND

### 1. Technical Field

The present disclosure relates to a microcontroller that maintains a control function even after a soft reset and a controlling method thereof, and more particularly to a microcontroller that does not require operations such as communication reconnection or calibration data reconstruction according to a soft reset situation even if the soft reset situation occurs for the microcontroller and a controlling method thereof.

### 2. Description of the Related Art

The statements in this section merely provide background information related to the present disclosure and may not constitute prior art.

A controlled device may be controlled using a microcontroller. In this case, calibration data for precisely controlling the controlled device during the operation of the microcontroller may be stored in a memory provided in the microcontroller. In addition, the microcontroller may be communicatively connected to enable data transmission and reception with an external device and may receive the calibration data.

However, as the microcontroller continues to operate, a situation may occur in which a soft reset must be performed. The microcontroller may perform the soft reset by determining by itself the situation in which the soft reset must be performed, or in response to receiving a reset command from the outside.

However, when such a soft reset is performed, data recorded in the microcontroller's internal memory is generally initialized. Accordingly, the calibration data recorded in the microcontroller's internal memory and even data necessary for communication connection with external devices may be initialized. When the calibration data and the data for the communication connection are initialized, the microcontroller is temporarily unable to perform the control function for the controlled device.

If the controlled device is a key driving device related to a driving of a vehicle, temporary loss of the control function due to the soft reset described above may cause serious safety problems.

### SUMMARY

Aspects of the present disclosure provide a microprocessor that maintains data necessary to maintain a control function for a controlled device despite a soft reset without initializing the data, and a controlling method using the microprocessor.

Aspects of the present disclosure also provide a microprocessor that maintains calibration data for a controlled device despite a soft reset without initializing the calibration data, and a controlling method using the microprocessor.

Aspects of the present disclosure also provide a microprocessor that performs a soft reset so that a communication connection between the microprocessor and an external device is maintained despite memory initialization caused by the soft reset, and a controlling method using the microprocessor.

Aspects of the present disclosure also provide a microcontroller that allows a calibration function to be performed by initializing memory data excluding a memory area where the calibration function is performed, in a process of initializing the memory data due to initialization of the microcontroller, and a controlling method using the microcontroller.

Aspects of the present disclosure also provide a microcontroller that maintains a communication status of a communication module even when soft is initialized because communication setting information before the communication module of the microcontroller is reset is stored in a non-volatile memory, and a controlling method using the microcontroller.

However, aspects of the present disclosure are not restricted to those set forth herein. The above and other aspects of the present disclosure should become more apparent to one of ordinary skill in the art to which the present disclosure pertains by referencing the detailed description of the present disclosure given below.

According to an aspect of the present disclosure, there is provided a microcontroller that performs a control function. The microcontroller may comprise: a memory management unit (MMU) performing a soft reset process by initializing remaining areas excluding a working page area of a memory managed by the memory management unit of the microcontroller; a communication module maintaining a communication connection prior to the soft reset process as it is even after the soft reset process; and a microprocessor initialized according to the soft reset process.

In some embodiments, the communication module generates a control signal related to the storage of communication setting information before the soft reset occurs in order to maintain a communication connection state even when the soft reset occurs, stores the communication setting information in a non-volatile memory provided in the communication module, and re-establishes the communication state using the stored communication setting information.

In some embodiments, the communication setting information includes physical communication channel information of the communication module before reset, measurement variable table registered for data measurement, page information set for calibration, and unit block information of a working page allocated for calibration.

In some embodiments, the physical communication channel information includes information on a plurality of communication channels before reset when the communication module supports the plurality of communication channels.

In some embodiments, the control signal related to the storage of the communication setting information is generated by waiting until all of the communication setting information before reset is acquired at the same time in order to maintain the communication state before reset even after reset.

In some embodiments, the communication module performs re-establishment of the communications state in response to the microprocessor being initialized.

In some embodiments, the memory management unit generates a control signal related to the storage of memory setting information before the soft reset occurs in order to maintain the calibration function when a soft reset situation occurs, and re-establishes the memory based on the stored memory setting information and the re-established communication state.

In some embodiments, the memory setting information includes information of a calibration memory block held by the memory management unit before reset and a changed calibration value.

In some embodiments, the memory management unit performs the re-establishment of the memory in response to the microprocessor being initialized.

In some embodiments, the memory management unit performs a determination on consistency of the memory stored in the working page area before reset, and performs the re-establishment of the memory based on currently set page information after reset.

In some embodiments, when the consistency of the memory stored in the working page area is normal, the memory management unit loads memory information of the working page area stored before soft reset and then reallocates a memory unit block of the working page area after the soft reset based on the memory information of the working page area.

In some embodiments, when the consistency of the memory stored in the working page area is normal and the currently set page information is a reference page, the memory management unit performs the re-establishment of the memory based on a calibration variable value of a flash area.

In some embodiments, when the consistency of the memory stored in the working page area is normal and the currently set page information is a working page, the memory management unit performs the re-establishment of the memory based on a variable value of a RAM area changed with calibration.

In some embodiments, when the consistency of the memory stored in the working page area is abnormal, the memory management unit performs initialization of the memory in the working page, initializes a memory error correction code calculation value, and initializes unit block setting information of the working page to an initial value.

According to another aspect of the present disclosure, there is provided a method for a microcontroller including a memory management unit, a communication module, and a microprocessor to perform a control function. The method may comprise: performing a soft reset process of initializing remaining areas excluding a working page area of a memory managed by the memory management unit of the microcontroller; maintaining a communication connection prior to the soft reset process as it is even after the soft reset process; and performing initialization according to the soft reset process.

In some embodiments, the maintaining of the communication connection as it is includes generating a control signal related to the storage of communication setting information before the soft reset occurs in order to maintain a communication connection state even when the soft reset occurs, storing the communication setting information in a non-volatile memory provided in the communication module, and re-establishing the communication state using the stored communication setting information.

In some embodiments, the communication setting information includes physical communication channel information of the communication module before reset, measurement variable table registered for data measurement, page information set for calibration, and unit block information of a working page allocated for calibration.

In some embodiments, the control signal related to the storage of the communication setting information is generated by waiting until all of the communication setting information before reset is acquired at the same time in order to maintain the communication state before reset even after reset.

In some embodiments, the maintaining of the communication connection as it is includes performing the re-establishment of the communications state in response to the microprocessor being initialized.

In some embodiments, the performing of the soft reset includes generating a control signal related to the storage of memory setting information before the soft reset occurs in order to maintain the calibration function when a soft reset situation occurs, and re-establishing the memory based on the stored memory setting information and the re-established communication state.

### BRIEF DESCRIPTION OF THE DRAWINGS

The above and other aspects and features of the present disclosure should become more apparent by describing in detail embodiments thereof with reference to the attached drawings, in which:

FIG. 1 is a configuration view of a microcontroller according to an embodiment of the present disclosure;

FIG. 2 is a view illustrating in detail some operations of the microcontroller described with reference to FIG. 1;

FIG. 3 is a flowchart of a controlling method using a microcontroller according to another embodiment of the present disclosure;

FIGS. 4-7 are detailed flowcharts illustrating in detail some operations of the controlling method using the microcontroller described with reference to FIG. 3;

FIG. 8 is a signal flowchart illustrating in detail some operations of the controlling method using the microcontroller described with reference to FIG. 3; and

FIG. 9 is a hardware configuration view of a control device according to another embodiment of the present disclosure.

### DETAILED DESCRIPTION OF THE EMBODIMENTS

Hereinafter, embodiments of the present disclosure are described with reference to the attached drawings. Advantages and features of the present disclosure and methods of accomplishing the same may be understood more readily by reference to the following detailed description of the disclosed embodiments and the accompanying drawings. The present disclosure may, however, be embodied in many different forms and should not be construed as being limited to the embodiments set forth herein. Rather, these embodiments are provided so that this disclosure is thorough and complete and fully conveys the concept of the disclosure to those of ordinary skill in the art. The present disclosure is only defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof is omitted.

Unless otherwise defined, all terms used in the present specification (including technical and scientific terms) may be used in a sense that can be commonly understood by those of ordinary skill in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase. When a component, device, element, or the like of the present disclosure is described as having a purpose or performing an operation, function, or the like, the component, device, or element should be considered herein as being “configured to” meet that purpose or to perform that operation or function.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure are described with reference to the attached drawings.

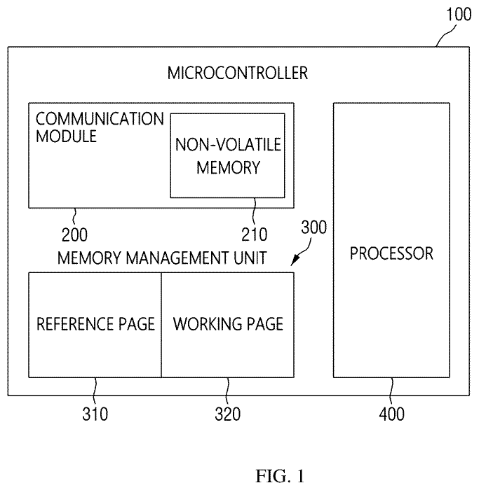

A microcontroller 100 that maintains communication connection and performs a control function even after a soft reset according to an embodiment of the present disclosure is described with reference to FIG. 1.

FIG. 1 is a configuration view of a module embedded in a microcontroller 100 according to an embodiment of the present disclosure. The microcontroller 100 according to the present embodiment may include a communication module 200, a memory management unit 300, and a processor 400, as illustrated in FIG. 1. The communication module 200 may include a non-volatile memory 210 that stores communication setting information and the memory management unit 300 may include a memory in a reference page 310 area and a memory in a working page 320 area.

The microcontroller 100 according to an embodiment of the present disclosure may be included inside an electronic control unit, and objects controlled by the electronic control unit may be related to ABS, airbags, steering, etc., and may include all objects requiring control within a vehicle. In other words, the meaning of the electronic control unit used in embodiments of the present disclosure is not limited to an engine control unit, but collectively refers to all individual electronic control units such as transmission, airbag, and tire pressure management.

According to embodiments of the present disclosure, when the electronic control unit performs control, calibration and data measurement may be performed through a protocol of the communication module 200. The communication module 200 may be based on a communication protocol such as universal measurement and calibration protocol (XCP), CAN, etc., and is not limited thereto as long as it is a communication protocol that may perform calibration and data measurement functions according to embodiments of the present disclosure.

The main purpose of the communication module 200 may be to maintain a connection state even after a soft reset due to a reset of the microcontroller 100. The reason why a reset occurs may be that a voltage input to the microcontroller 100 increases too quickly for the microcontroller 100 to accept. Accordingly, if the microcontroller abnormally operates, a System Reset signal is generated inside the microcontroller 100 to reset the microcontroller 100. In addition to forcibly resetting the microcontroller 100 when an abnormal operation is detected, it may also be possible for the user to arbitrarily reset the microcontroller 100. Therefore, the communication module 200 may include an initialization function and a function capable of detecting an abnormal operation of the microcontroller 100.

The communication module 200 according to an embodiment of the present disclosure may perform a calibration function and a data measurement function for a control object in a vehicle. Calibration is related to how parameters contained in the electronic control unit that performs a specific function in the vehicle may be modified, and is a process of obtaining an optimal value of a specific parameter through repeated measurement and change. Therefore, to improve a performance of the electronic control unit that performs a specific function, the optimal value needs to be obtained through repeated data measurement, and if a change in the optimal value is required depending on external factors, the optimal value may be changed through the calibration function. The communication module 200 within the microcontroller 100 may measure data using a protocol such as XCP and change an optimal value of the data.

The communication module 200 according to another embodiment of the present disclosure may store communication setting information in a non-volatile memory before the soft reset occurs due to the reset of the microcontroller 100. The communication setting information may include physical communication channel information, calibration page information, start address and size information of variables registered for data measurement, working page 320 memory block information, etc. The communication setting information is not limited thereto, and may include any information as long as it is information necessary to maintain a communication connection even after the reset and perform the calibration and data measurement functions.

The physical communication channel information according to an embodiment of the present disclosure may also include information on a plurality of communication channels before the reset when the communication module 200 supports the plurality of communication channels. In addition, when the communication module 200 supports only a single communication channel, storing the physical communication channel information in the non-volatile memory 210 may be omitted.

The non-volatile memory 210 that stores the communication setting information may be composed of a flash memory, an external electrically erasable programmable ROM (EEPROM) memory, a non-volatile RAM (NVRAM), etc. In addition, the non-volatile memory 210 may be mounted inside the communication module 200, and may also be provided outside the communication module unlike illustrated in FIG. 1.

According to an embodiment of the present disclosure, the communication setting information is information necessary to maintain the communication state before soft initialization due to the reset of the microcontroller 100, and may be stored in the non-volatile memory 210 by waiting until all communication setting information is acquired for the same point in time before the reset of the microcontroller.

The communication module 200 according to another embodiment of the present disclosure may re-establish the communication state using the stored communication setting information. The re-establishment of the communication state may be performed in response to the microprocessor being initialized, and as the communication state before communication is maintained even after the soft reset through the resetting of the communication state, the user may perceive that the communication state is not interrupted.

The memory management unit 300 according to an embodiment of the present disclosure may include a memory in a reference page 310 area and a memory in a working page 320 area. The memory in the reference page 310 area may include values of calibration-capable variables stored in the area when calibration is not used, and the microcontroller 100 may perform control using the calibration-capable variables included in the memory in the reference page 310 area.

Unlike this, the memory in the working page 320 area according to an embodiment of the present disclosure may include values of changed calibration variables stored in the area when calibration is used, and the microcontroller 100 may perform control using the calibration variables included in the memory in the working page 320 area.

The main purpose of the memory management unit 300 may be to maintain calibration and data measurement functions even after the soft reset due to the reset of the microcontroller 100. Therefore, the memory may be initialized except for the memory in the working page 320 area used when using calibration.

The memory management unit 300 according to an embodiment of the present disclosure may store memory setting information necessary for maintaining the calibration function before the reset of the microcontroller 100 occurs. The memory setting information may include memory block information, changed calibration values, etc., but is not limited thereto and may include all information for maintaining the calibration function.

The memory management unit 300 according to another embodiment of the present disclosure may re-establish the memory using the stored memory setting information and the re-established communication module. The re-establishment of the memory may be performed in response to the microprocessor being initialized, thereby maintaining the calibration function even after the soft reset.

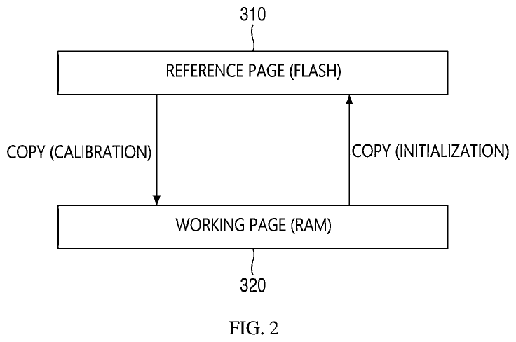

FIG. 2 is an view for describing a reference page 310 and a working page 320 according to an embodiment of the present disclosure. The reference page 310 and the working page 320 are memory areas included in the memory management unit 300, the reference page 310 may store calibration-capable variable values in a flash memory, and the working page 320 may store calibration variable values in a RAM memory.

The memory in the reference page 310 area is an area where a base value of the calibration-capable variable exists, and when the microcontroller 100 is not using calibration, the microcontroller 100 may perform control based on the corresponding base value. In addition, the working page 320 area is an area where a variable value changed when using calibration is stored in the RAM memory, and the microcontroller 100 may perform control based on the changed variable value. In other words, the working page 320 is an area necessary for the calibration function to be performed, and if the microcontroller 100 does not use the calibration function, the microcontroller 100 may control the vehicle using the variable value of the reference page 310.

According to another embodiment of the present disclosure, the values of the calibrated variables are stored in the memory in the working page 320 area, and the calibration function may be provided to the user even after the reset of the microcontroller 100 only if the values of the calibrated variables exist even after the reset of the microcontroller 100. Therefore, even when the memory is initialized due to the reset of the microcontroller, the memory may be initialized except for the working page 320 area.

The pages of the reference page 310 and the working page 320 may be freely changed by the user's selection. As an example, even if the calibration has been performed, the user may change the page from the working page 320 to the reference page 310 if necessary. Likewise, even if the calibration is not performed, the user may change the page from the reference page 310 to the working page 320 if necessary.

According to another embodiment of the present disclosure, when the memory is initialized because memory consistency of the working page 320 is abnormal, it may be necessary to copy data of the working page 320 to data of the reference page 310. In addition, even when performing the calibration function, it may be necessary to copy the data of the reference page 310 to the data of the working page 320. A detailed description thereof is provided later through the drawings.

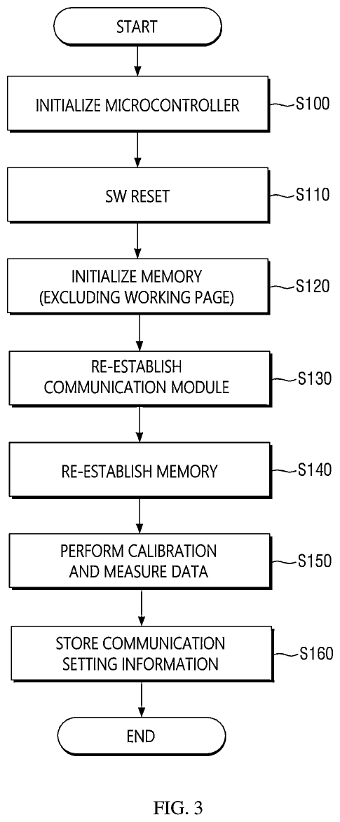

Hereinafter, a controlling method according to another embodiment of the present disclosure is described with reference to FIG. 3. The controlling method according to the present embodiment may be performed, for example, using the microcontroller described with reference to FIG. 1.

First, the microcontroller may detect that an abnormal operation occurs due to a sudden increase in an applied voltage, and determine to perform initialization (S100).

If it is determined to perform the initialization, the microcontroller may generate a System Reset signal. A soft reset may be performed using the System Reset signal as a trigger.

The microcontroller may perform memory initialization for areas excluding the working page area (S120). Information in the working page area may be managed by the memory management unit provided in the microcontroller. The working page area is an area where data necessary for calibration and data measurement, such as variable values for which calibration is performed, is stored, and may be, for example, a partial area of a volatile memory such as random-access memory (RAM).

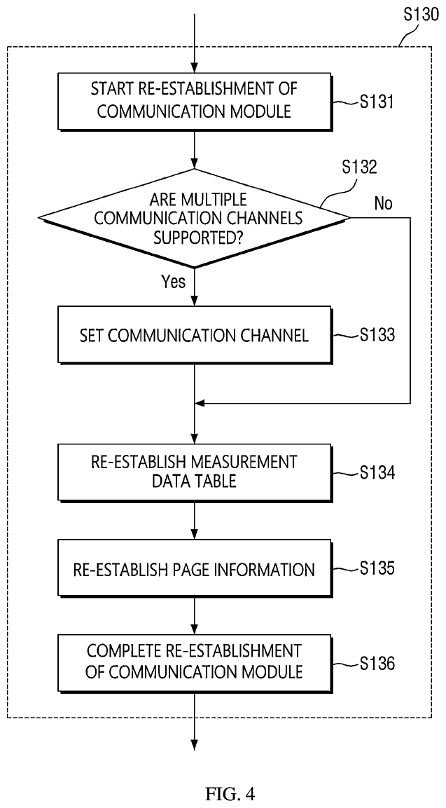

The microcontroller may maintain the communication connection as it is before the microcontroller is reset by re-establishing the communication module 200 based on the communication setting information stored in the non-volatile memory (S130). Step S130 is described in detail later in FIG. 4.

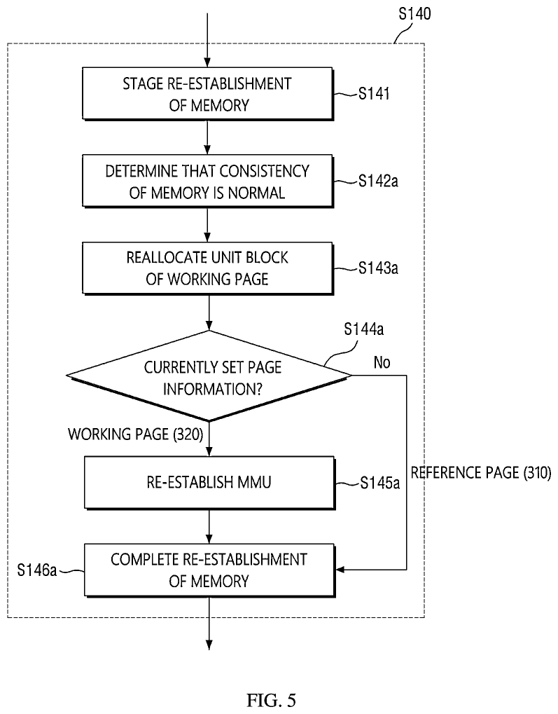

The microcontroller may re-establish the memory based on the re-established communication module and calibration-related memory storage information to maintain the calibration and data measurement functions performed before the microcontroller is reset. Step S140 is described in detail later with reference to FIGS. 5-7.

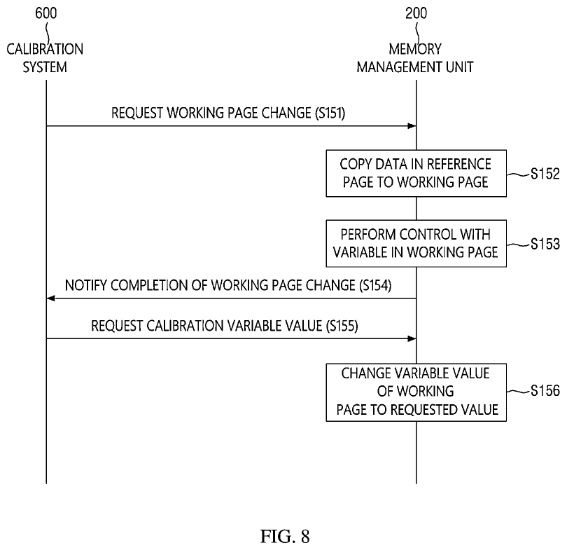

The microcontroller may perform the calibration and data measurement functions performed before the soft reset based on the communication connection and calibration functions maintained based on the operations of steps S130 and S140. Step S150 described in detail with reference to FIG. 8.

The microcontroller may store communication setting information during runtime when performing the calibration and data measurement of the microcontroller (S160). The communication setting information may be stored in a non-volatile memory provided in the microcontroller. The non-volatile memory is managed by the memory management unit provided in the microcontroller and may be, for example, built into the communication module as a memory separate from the memory subject to initialization due to the soft reset.

As the communication setting information is stored in the memory separate from the memory subject to initialization, the communication connection before the soft reset may be maintained as it is. For example, an XCP connection between the microcontroller and an external device may be maintained as it is.

Hereinafter, the above-described communication module re-establishing step (S130) is described in detail with reference to FIG. 4.

First, if the re-establishment of the communication module begins in step S131, whether or not a communication channel is set may vary depending on whether the communication module uses multiple communication channels or a single communication channel (S132). If the communication module transmits and receives data using the multiple communication channels, the communication module may set the communication channel of the microcontroller in step S133. Information on the communication channel setting may be stored in the non-volatile memory within the communication module of the microcontroller. If the communication module 200 does not support the multiple communication channels, the communication channel setting in step S133 may be omitted.

After the communication channel setting is completed, a measurement data table may be re-established based on the measurement data information stored in the non-volatile memory 210 in step S134. In this case, the measurement data table may be a set of the starting address and size of data related to calibration.

After the setting of the data measurement table is completed, current page setting information may be re-established in step S135. The page information may include a reference page 310 and a working page 320, and the variable values used when performing the calibration function may vary depending on the currently set page information.

The microcontroller stores the currently set page information before reset in the non-volatile memory 210, and a step of re-establishing the currently set page information may be necessary to maintain the communication state and perform the calibration function after the reset. If the re-establishment of the currently set page information is completed, the re-establishing step of the communication module 200 is completed (S136), and the communication state of the communication module may be maintained even after the microcontroller is reset.

Hereinafter, the above-described memory re-establishing step (S140) is described in detail with reference to FIG. 5. FIG. 5 is a detailed flow chart for describing a case where memory consistency is normal when re-establishing the memory module of the microcontroller.

If the microcontroller is initialized by soft reset, the memory management unit may perform re-establishment of the memory based on the information stored before the soft reset and the re-established communication module (S141). Since the memory was initialized excluding the memory in the working page area when initializing the memory according to the initialization of the microcontroller in step S120 of FIG. 3, it may be necessary to determine whether consistency of the memory in the working page area that has not been initialized is normal in re-establishing the memory according to some embodiments of the present disclosure. In addition, a method of determining whether the currently set page information is a reference page or a working page and re-establishing the memory of the microcontroller may vary accordingly.

Consistency of the memory means that memories need to consistently match each other without contradiction. Even in some embodiments of the present disclosure, it may be necessary to determine consistency whether the memories in the working page area are consistent and match with each other. If the consistency of the memory in the working page area is determined to be normal in step S142a, the memory management unit may load allocated working page information stored before the soft reset and then reallocate a unit block of the working page based on the corresponding working page information (step S143a).

After the consistency of the working memory is determined to be normal according to some embodiments of the present disclosure, a memory re-establishment operation flow of the memory management unit may be divided depending on whether the currently set page information is a reference page or a working page.

Before that, a general operation of the memory management unit MMU is as follows. The memory management unit may convert an address in a virtual memory (e.g., Flash memory) into an address in a real memory (e.g., RAM), and the processor indicates the address in the virtual memory with an address of an instruction to be executed. According to some embodiments of the present disclosure, since the memory in the reference page area may correspond to a virtual memory and the memory in the working page area may correspond to a real memory, the re-establishment operation flow of the memory management unit may vary depending on the currently set page information (step S144a).

For example, if the currently set page information is a reference page, the memory in the reference page area is the virtual memory and the processor's instruction indicates the address of the virtual memory. Therefore, the step of re-establishing the MMU in S145a is omitted and the microcontroller performs the re-establishment of the memory based on the calibration variable value in the Flash area. In addition, if the currently set page information is the working page, the memory in the working page is the real memory. Therefore, the processor may need to access a virtual address memory in the step of re-establishing the MMU. Therefore, after completing the step of re-establishing the MMU, which is the process of converting the corresponding virtual address to the real address value, the memory management unit may complete the re-establishment of the memory (step S146a).

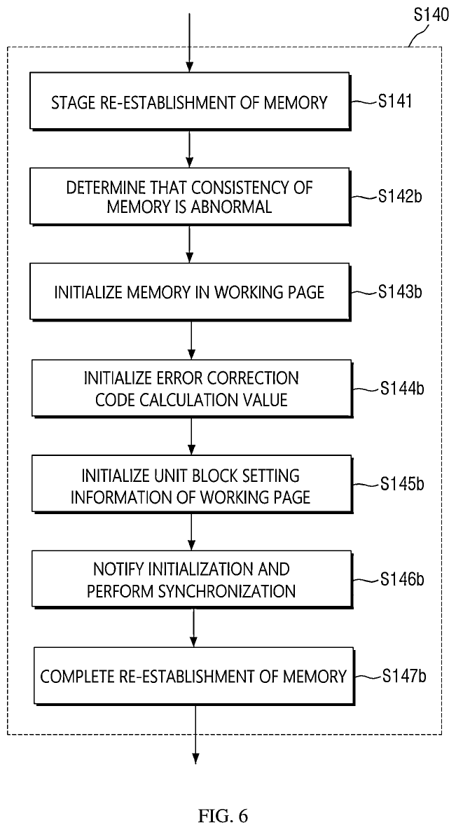

Hereinafter, the above-described memory re-establishing step (S140) is described in detail again with reference to FIG. 6. FIG. 6 is a detailed flow chart of a case where memory consistency is abnormal when re-establishing the memory module of the microcontroller.

In some embodiments, if the consistency is abnormal because the working page memory does not match (S142b), the memory management unit may initialize the working page memory itself (S143b). In addition, if the microcontroller provides an error correction code function of a memory, the memory management unit may also initialize a memory error correction code calculation value (S144b).

After the initialization of the memory error correction code calculation value is completed, the memory management unit may initialize the unit block setting information of the working page to an initial value (S145b). By initializing the unit block setting information of the working page to the initial value, it is possible to prevent the information allocated to the working page from being used as is at runtime before the microcontroller is reset.

After initializing the unit block setting information of the working page, the memory management unit may transmit an initialization notification that the calibration function of the microcontroller has been initialized to an external device. According to embodiments of the present disclosure, the external device may include a calibration system 600. The calibration system 600 may be another device in the vehicle that manages electronic control devices and may transmit and receive information related to calibration and data measurement to the microcontroller of the electronic control device.

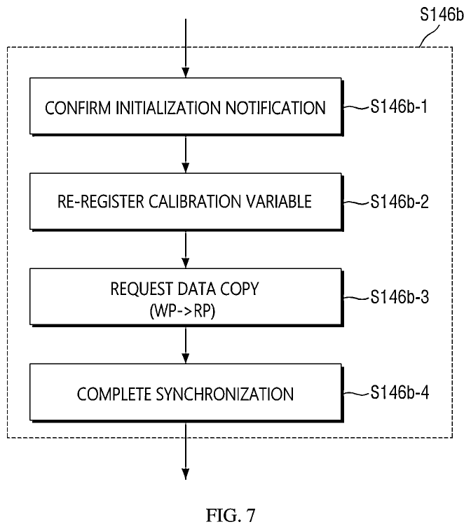

The microcontroller may generate a notification message notifying the initialization of the working page, and may transmit the notification message to the calibration system so that the notification message may be displayed. When receiving a confirmation signal for initialization in response to the notification message, the microcontroller may complete the establishment of the memory (S147b) by performing a synchronization task of a calibration page (S146b). A method for the synchronization task of the calibration page (S146b) is described in more detail with reference to FIG. 7.

As described above, if the consistency of the memory in the working page area is determined to be abnormal, the microcontroller may transmit the notification message notifying the initialization of the calibration function to the calibration system. In addition, the calibration system 600 may receive a user confirmation operation according to the notification message (S146b-1).

In addition, when receiving a signal for the user confirmation from the calibration system, the microcontroller may perform the synchronization of the working page. In this case, the synchronization of the working page may include re-registering the calibration variable in the memory in the working page area (S146b-2).

Next, the microcontroller may copy data in the working page area to data in the reference page (S146b-3). Accordingly, the synchronization task of the working page of the microcontroller may be completed (S146b-4).

Hereinafter, the controlling method according to the present embodiment is described in more detail with reference to FIG. 8.

According to some embodiments of the present disclosure, the calibration system 600 may be another device in the vehicle that manages the electronic control devices and may transmit and receive information related to calibration and data measurement to the microcontroller 100 of the electronic control device. The number of devices (hereinafter referred to as calibration systems) capable of performing the calibration system 600 in the vehicle may be plural, but since such a calibration system may have a master-slave relationship with the electronic control devices, one calibration system 600 may control one or more electronic control devices.

The process of performing the calibration according to some embodiments of the present disclosure may involve changing the currently set page to the working page if the currently set page is the reference page. Accordingly, in step S151, the calibration system 600 may request the memory management unit 300 to change the page to the working page.

In step S152, the memory management unit may copy the data of the reference page to the memory in the working page area. In addition, in step S153, the microcontroller may perform calibration with variable values included in the memory in the copied working page area, and in step S154, the memory management unit may notify the calibration system 600 of the completion of the working page change.

In addition, when a change in an optimal calibration value of the controlled device is required depending on external factors, the microcontroller may change the optimal calibration value. Accordingly, the calibration system 600 in step S155 may request a calibration variable value from the memory management unit 300. In addition, the memory management unit 300 may change the variable value of the working page to the requested value using the variable value requested from the calibration system 600 (S156).

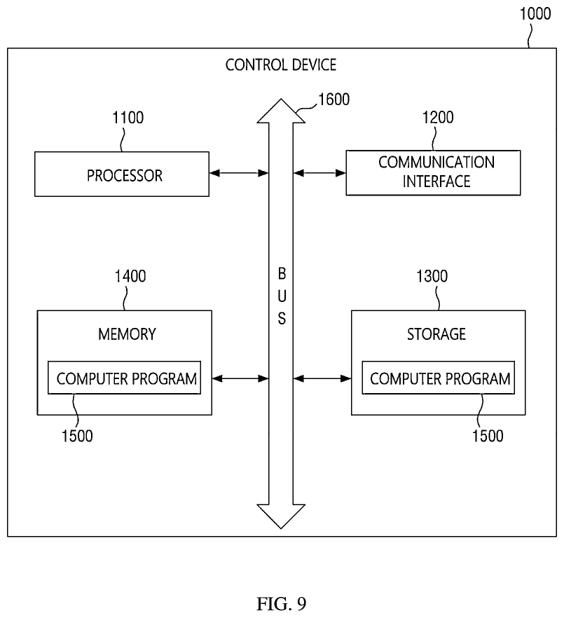

Hereinafter, a control device 1000 according to another embodiment of the present disclosure is described with reference to FIG. 9. For example, the control device 1000 is a device for controlling one or more controlled devices provided in a vehicle, and may be provided in the vehicle.

FIG. 9 is a hardware configuration view of the control device 1000 according to the present embodiment. The control device 1000 may include one or more processors 1100, a system bus 1600, a communication interface 1200, a memory 1400 for loading a computer program 1500 executed by the processor 1100, and a storage 1300 for storing the computer program 1500.

The processor 1100 performs calculations for controlling a controlled device (not illustrated) controlled by the control device 1000. For example, the processor 1100 may be configured using the microcontroller described with reference to FIG. 1. The processor 1100 may include a memory management unit (not illustrated) that manages the memory 1400.

The processor 1100 controls the overall operation of each component of the control device 1000. The processor 1100 may perform a calculation on at least one application or program for executing the methods/operations according to various embodiments of the present disclosure. The memory 1400 stores various data, instructions, and/or information. The memory 1400 may load one or more programs 1500 from the storage 1300 to execute the methods/operations according to various embodiments of the present disclosure. The bus 1600 provides a communication function between the components of the control device 1000. The communication interface 1200 supports Internet communication of the control device 1000. The storage 1300 may non-temporarily store one or more computer programs 1500. The computer program 1500 may include one or more instructions in which the methods/operations according to various embodiments of the present disclosure are implemented. When the computer program 1500 is loaded into the memory 1400, the processor 1100 may perform the methods/operations according to various embodiments of the present disclosure by executing the one or more instructions.

The computer program 1500 may include instructions for performing a soft reset process by initializing remaining areas excluding a working page area of the memory 1400 managed by the memory management unit MMU of the processor 1100, and instructions for maintaining a communication connection prior to the soft reset process even after the soft reset process. The computer program 1500 may be implemented by applying technical ideas that may be understood through other embodiments described above.

The communication interface 1200 transmits and receives data with another control device (not illustrated) or a controlled device (not illustrated) in the vehicle. For example, the communication interface 1200 may be connected to a controller area network (CAN)-based network or an Ethernet-based network.

So far, a variety of embodiments of the present disclosure and the effects according to embodiments thereof have been mentioned with reference to FIGS. 1-9. The effects according to the technical idea of the present disclosure are not limited to the aforementioned effects, and other unmentioned effects may be clearly understood by those of ordinary skill in the art from the description of the specification.

The technical features of the present disclosure described so far may be embodied as computer readable codes on a computer readable medium. The computer readable medium may be, for example, a removable recording medium (compact disk (CD), digital video disk (DVD), Blu-ray disk, universal serial bus (USB) storage device, removable hard disk) or a fixed recording medium (read-only memory (ROM), random-access memory (RAM), computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those of ordinary skill in the art should appreciate that many variations and modifications can be made to the embodiments without substantially departing from the principles of the present disclosure. Therefore, the disclosed embodiments of the disclosure are used in a generic and descriptive sense only and not for purposes of limitation.

What is claimed is:

1. A microcontroller that performs a control function, the microcontroller comprising:
a memory management unit (MMU) configured to perform a soft reset process by initializing remaining areas excluding a working page area of a memory managed by the memory management unit of the microcontroller;
a communication module configured to maintain a communication connection prior to the soft reset process as it is even after the soft reset process; and
a microprocessor initialized according to the soft reset process.

2. The microcontroller of claim 1, wherein the communication module is configured to:
generate a control signal related to the storage of communication setting information before the soft reset occurs in order to maintain a communication connection state even when the soft reset occurs;
store the communication setting information in a non-volatile memory provided in the communication module; and
re-establish the communication state using the stored communication setting information.

3. The microcontroller of claim 2, wherein the communication setting information includes physical communication channel information of the communication module before reset, measurement variable table registered for data measurement, page information set for calibration, and unit block information of a working page allocated for calibration.

4. The microcontroller of claim 3, wherein the physical communication channel information includes information on a plurality of communication channels before reset when the communication module supports the plurality of communication channels.

5. The microcontroller of claim 2, wherein the control signal related to the storage of the communication setting information is generated by waiting until all of the communication setting information before reset is acquired at the same time in order to maintain the communication state before reset even after reset.

6. The microcontroller of claim 2, wherein the communication module is configured to perform re-establishment of the communications state in response to the microprocessor being initialized.

7. The microcontroller of claim 1, wherein the memory management unit is configured to:
generate a control signal related to the storage of memory setting information before the soft reset occurs in order to maintain calibration when a soft reset situation occurs; and
re-establish the memory based on the stored memory setting information and the re-established communication state.

8. The microcontroller of claim 7, wherein the memory setting information includes information of a calibration memory block held by the memory management unit before reset and a changed calibration value.

9. The microcontroller of claim 7, wherein the memory management unit is configured to perform the re-establishment of the memory in response to the microprocessor being initialized.

10. The microcontroller of claim 7, wherein the memory management unit is configured to perform a determination on consistency of the memory stored in the working page area before reset, and perform the re-establishment of the memory based on currently set page information after reset.

11. The microcontroller of claim 10, wherein when the consistency of the memory stored in the working page area is normal, the memory management unit is configured to load memory information of the working page area stored before soft reset and then reallocate a memory unit block of the working page area after the soft reset based on the memory information of the working page area.

12. The microcontroller of claim 11, wherein when the consistency of the memory stored in the working page area is normal and the currently set page information is a reference page, the memory management unit is configured to perform the re-establishment of the memory based on a calibration variable value of a flash area.

13. The microcontroller of claim 11, wherein when the consistency of the memory stored in the working page area is normal and the currently set page information is a working page, the memory management unit is configured to perform the re-establishment of the memory based on a variable value of a RAM area changed with calibration.

14. The microcontroller of claim 10, wherein when the consistency of the memory stored in the working page area is abnormal, the memory management unit is configured to perform initialization of the memory in the working page, initialize a memory error correction code calculation value, and initialize unit block setting information of the working page to an initial value.

15. A method for a microcontroller including a memory management unit, a communication module, and a microprocessor to perform a control function, the method comprising:
performing a soft reset process of initializing remaining areas excluding a working page area of a memory managed by the memory management unit of the microcontroller;
maintaining a communication connection prior to the soft reset process as it is even after the soft reset process; and
performing initialization according to the soft reset process.

16. The method of claim 15, wherein maintaining the communication connection includes:
generating a control signal related to the storage of communication setting information before the soft reset occurs in order to maintain a communication connection state even when the soft reset occurs;
storing the communication setting information in a non-volatile memory provided in the communication module; and
re-establishing the communication state using the stored communication setting information.

17. The method of claim 16, wherein the communication setting information includes physical communication channel information of the communication module before reset, measurement variable table registered for data measurement, page information set for calibration, and unit block information of a working page allocated for calibration.

18. The method of claim 16, wherein the control signal related to the storage of the communication setting information is generated by waiting until all of the communication setting information before reset is acquired at the same time in order to maintain the communication state before reset even after reset.

19. The method of claim 15, wherein maintaining the communication connection includes performing the re-establishment of the communications state in response to the microprocessor being initialized.

20. The method of claim 15, wherein performing the soft reset includes:
generating a control signal related to the storage of memory setting information before the soft reset occurs in order to maintain calibration when a soft reset situation occurs; and
re-establishing the memory based on the stored memory setting information and the re-established communication state.
